(19) United States
(12) Patent Application Publication
(10) Pub. No.: US 2026/0166621 A1
(43) Pub. Date: Jun. 18, 2026

(54) ADDITIVE MANUFACTURING POWDER COMPRISING METAL-BASED PARTICLES AND RELATED METHODS

(71) Applicant: EQUISPHERES INC., Ottawa (CA)

(72) Inventors: Martin John CONLON, Ottawa (CA); Jose Alberto MUNIZ-LERMA, Ottawa (CA); Evan BUTLER-JONES, Ottawa (CA)

(21) Appl. No.: 19/129,366

(22) PCT Filed: Nov. 15, 2023
(86) PCT No.: PCT/CA2023/051537

§ 371 Date: May 13, 2025

Related U.S. Application Data
(60) Provisional application No. 63/383,792, filed on Nov. 15, 2022.

(51) Int. Cl. B22F 1/05; B22F 1/065; B22F 1/14; B33Y 70/00

(52) U.S. Cl. CPC B22F 1/05; B22F 1/065; B22F 1/14; B33Y 70/00; B22F 2301/052; B22F 2304/10; B22F 2999/00

(57) ABSTRACT

There are provided a metal-based powder comprising metal-based particles, a method to produce a conditioned powder for use in an additive manufacturing, and a method for printing a density artefact via additive manufacturing using the metal-based powder. Morphology of the metal-based particles is defined by a median aspect ratio greater than or equal to 0.85 and the fine content of the metal-based powder can be defined by a cumulative size distribution (CSD) by count including less than 20% of the metal-based particles by count that are smaller than 53 μm. Other criteria can be used to define the metal-based powder including a specific surface area of at most 0.075 m²/g, a particle size distribution between about 53 μm and about 150 μm, and a fine content being defined by a particle count of at most 500,000 particles per gram having a diameter smaller than or equal to 15 μm.

### TECHNICAL FIELD

The technical field relates to spheroidal metal-based powders for additive manufacturing processes. More specifically, it relates to a metal-based powder including spheroidal metal-based particles being characterized by a combination of specific physical and chemical properties being suitable for layer-wise manufacturing processes whilst also being non-combustible and non-explosible. It also relates to parts made by additive manufacturing using the metal-based powder.

### BACKGROUND

Metal additive manufacturing (AM) processes such as powder bed fusion and binder jetting use finely divided metal particles as a feedstock. The handling and processing of this feedstock require substantial infrastructure, personal protective equipment, and process controls because these metal powders are classified as combustible and/or explosible dusts that can catch fire and/or explode when dispersed in air and exposed to an ignition source. These hazards are further increased when the metal powder is a reactive material such as aluminum.

Due to the layer-wise build process of AM, complex geometries can be obtained, some of which would be impossible to produce using traditional casting, forming or subtractive manufacturing processes. These complex geometries can lead to weight reduction (lightweighting) of components, particularly when combined with alloys of aluminum, however, these aluminum-based powders present safety hazards.

As the use of these additive manufacturing processes becomes more common, the infrastructure and safety challenges are increasing. The resulting infrastructure and process costs reduce the economic potential of AM, amplified by the relatively slow production output of additive manufacturing processes compared to the required infrastructure.

In view of the above, there is a need for metal-based powders that would have enhanced properties which would be able to overcome or at least minimize some of the above-discussed concerns in the field of additive manufacturing.

### SUMMARY

The techniques described herein are proposed to address the above-mentioned issues.

In one aspect, there is provided a metal-based powder comprising metal-based particles. The powder has a specific surface area of at most 0.075 m²/g (measured based on Dynamic Image Analysis according to ISO 13322-2); and a particle size distribution between about 53 μm and about 150 μm (measured based on Dynamic Image Analysis according to ISO 13322-2).

In another aspect, there is provided metal-based powder comprising metal-based particles, the powder having:
a specific surface area of at most 0.075 m²/g (measured based on Dynamic Image Analysis according to ISO 13322-2);
a particle size distribution between about 53 μm and about 150 μm (measured based on Dynamic Image Analysis according to ISO 13322-2); and
a fine content being defined by a particle count of at most 500,000 particles per gram having a diameter smaller than or equal to 15 μm (being measured based on Dynamic Image Analysis according to ISO 13322-2).

In some embodiments, the particle size distribution can be between about 53 μm and 106 μm. Optionally, the particle size distribution can be between about 71 μm and 90 μm. In some embodiments, the particle size distribution can be further characterized by a D₉₅ being of at least 90 μm. In some embodiments, the particle size distribution can be further characterized by a D₅₀ being of at least 70 μm.

In some embodiments, the specific surface area can be of at most 0.030 m²/g. Optionally, the specific surface area is of at most 0.050 m²/g.

In some embodiments, the metal-based particles are spheroidal and have a median aspect ratio greater than or equal to 0.85 (measured based on Dynamic Image Analysis according to ISO 13322-2). Optionally, the metal-based particles are spheroidal and have a median aspect ratio greater than or equal to 0.90 (measured based on Dynamic Image Analysis according to ISO 13322-2). Further optionally, the metal-based particles are spheroidal and have a median aspect ratio greater than or equal to 0.96 (measured based on Dynamic Image Analysis according to ISO 13322-2).

In another aspect, there is provided a metal-based powder comprising metal-based particles, the powder having:
a cumulative size distribution (CSD) by count including less than 20% of the metal-based particles by count that are smaller than 53 μm (measured by Dynamic Image Analysis according to ISO 13322-2), and
a median aspect ratio greater than or equal to 0.85 (measured based on Dynamic Image Analysis according to ISO 13322-2).

In some embodiments, the metal-based particles have a median aspect ratio greater than or equal to 0.90 (measured based on Dynamic Image Analysis according to ISO 13322-2). Optionally, the metal-based particles have a median aspect ratio greater than or equal to 0.96 (measured based on Dynamic Image Analysis according to ISO 13322-2).

In some embodiments, the CSD by count includes less than 20% of the metal-based particles by count that are smaller than 71 μm (measured by Dynamic Image Analysis according to ISO 13322-2).

In some embodiments, the metal-based powder has a fine content being defined by a particle count of at most 500,000 particles per gram having a diameter smaller than or equal to 15 μm (being measured based on Dynamic Image Analysis according to ISO 13322-2).

In some embodiments, the metal-based powder has a specific surface area of at most 0.075 m²/g (measured based on Dynamic Image Analysis according to ISO 13322-2). Optionally, the specific surface area can be of at most 0.030 m²/g. Further optionally, the specific surface area is of at most 0.050 m²/g.

In some embodiments, the metal-based powder has a particle size distribution between about 53 μm and about 150 μm (measured based on Dynamic Image Analysis according to ISO 13322-2). Optionally, the particle size distribution can be between about 53 μm and 106 μm. Further optionally, the particle size distribution can be between about 71 μm and 90 μm. In some embodiments, the particle size distribution can be further characterized by a D₉₅ being of at least 90 μm. In some embodiments, the particle size distribution can be further characterized by a D₅₀ being of at least 70 μm.

In some embodiments, the metal-based particles have a median sphericity greater than or equal to 0.90. Optionally, the metal-based particles have a median sphericity greater than or equal to 0.91. Further optionally, the metal-based particles have a median sphericity greater than or equal to 0.92. Yet further optionally, the metal-based particles have a median sphericity greater than or equal to 0.93.

In some embodiments, the metal-based particles have a moisture content being at most 250 ppm (being measured by Karl Fischer titration or moisture loss on drying during stepped heating). Optionally, the moisture content of the metal-based particles is at most 150 ppm (being measured by Karl Fischer titration or moisture loss on drying during stepped heating).

In some embodiments, the metal-based particles have an oxygen content being of at most 300 ppm (being measured by an inert gas fusion method). Optionally, the oxygen content of the metal-based particles is of at most 900 ppm (being measured by an inert gas fusion method). Further optionally, the oxygen content of the metal-based particles is of at most 1500 ppm (being measured by an inert gas fusion method).

In some embodiments, the metal-based particles comprise aluminum-based particles.

In some embodiments, the metal-based particles are aluminum-based particles.

Optionally, the aluminum-based particles comprise an aluminum alloy being AlSi10Mg, AlSi7Mg, AlCu, or any combinations thereof.

In some embodiments, the powder consists of the metal-based particles.

In some embodiments, the powder further comprises at least one additional component being a ceramic component, a lubricant, a binder, an additive or any combinations thereof. Optionally, the at least one additional component represents at most 10 wt % of the powder.

In yet another aspect, there is provided a method to condition a metal-based powder for use in an additive manufacturing process, with the metal-based powder comprising metal-based particles, the method comprising:
selecting a D₉₅ of the powder in accordance with a maximum layer thickness for a desired feature resolution of the additive manufacturing process;
performing at least one of sieving or dedusting of the powder to adjust a specific surface area (SSA) of the powder to a target value below an SSA threshold; and
recovering a coarser fraction to form a conditioned powder for use in the additive manufacturing process.

In some embodiments, the D₉₅ is selected to be at least 90 μm for the maximum layer thickness for the desired feature resolution being at most 50 μm.

In some embodiments, the SSA threshold is at most 0.075 m²/g.

In some embodiments, the method further comprises adjusting a fine content to recover the conditioned powder having a particle count of at most 500,000 particles per gram having a diameter smaller than or equal to 15 μm (being measured based on Dynamic Image Analysis according to ISO 13322-2).

In some embodiments, the conditioned powder is the metal-based powder as defined herein.

In yet another aspect, there is provided a method for printing a density artefact via additive manufacturing, the method including using the metal-based powder as defined herein at a build rate between 25 cm³/hr and 1000 cm³/hr. Optionally, the build rate can be between 100 cm³/hr and 600 cm³/h.

In some embodiments, the density artefact has a build density of at least 85% (measured by digital microscopy and image analysis). Optionally, the build density can be at least 95%. Further optionally, the build density is at least 99.8%.

The present document refers to a number of documents, the contents of which are hereby incorporated by reference in their entirety.

While the invention will be described in conjunction with example embodiments, it will be understood that it is not intended to limit the scope of the invention to such embodiments. On the contrary, it is intended to cover all alternatives, modifications and equivalents as may be included as defined by the present description. The objects, advantages and other features of the present invention will become more apparent and be better understood upon reading of the following non-restrictive description of the invention, given with reference to the accompanying drawings.

### BRIEF DESCRIPTION OF THE DRAWINGS

FIGS. 1a and 1b are scanning electron microscope images of a powder consisting of metal-based particles being AlSi10Mg particles tested in the example at two different magnification levels.

FIG. 2 is a graphical representation of the cumulative logarithmic particle size versus the standard deviation for the AISi10Mg-based powder.

FIG. 3 is a graphical representation of the number of particles per gram of the AlSi10Mg powder, grouped by particle size.

FIG. 4 is a graphical representation of the cumulative size distribution (CSD) by count being defined as the percentage of particles (by count) in % versus particle size in μm (measured by Retsch CAMSIZER X2) for a non-explosible AlSi10Mg-based powder according to one embodiment.

FIG. 5 is a graphical representation of a density (in %) of a printed density artefact (measured by digital optical microscopy and image analysis) versus a theoretical build rate of printing via additive manufacturing for three different layer thicknesses and two different laser powers.

FIG. 6 is an image of a polished cross-section of a density artefact that is printed using a metal-based powder according to an embodiment of the present invention at a print speed of 173 cm³/hr, thereby showing a resulting build density thereof.

FIG. 7 is another image of a polished cross-section of a density artefact that is printed using a metal-based powder according to an embodiment of the present invention at a build rate of 302 cm³/hr, thereby showing a resulting build density thereof.

FIG. 8 is another image of a polished cross-section of a density artefact that is printed using a metal-based powder according to an embodiment of the present invention at a build rate of 432 cm³/hr, thereby showing a resulting build density thereof.

### DETAILED DESCRIPTION

As used herein, the expression “additive manufacturing process” or “AM process” refers to processes such as powder bed fusion (PBF or LPBF for laser powder bed fusion) and binder jetting. In this context, it also encompasses powder processes such as directed energy deposition and cold spray.

As used herein, the term “powder” refers to a solid particulate material having a particle size distribution (defined by the D₅ and D₉₅) being in the range of about 53 μm to about 150 μm, optionally between 53 μm and 106 μm, further optionally between 53 μm and 90 μm, further optionally between 71 μm and 106 μm, and yet further optionally between 71 μm and 90 μm.

As used herein, the term “metal-based particle” means a particle principally comprised of a metal or metal alloy. In some embodiments the metal-based particle consists of one or more metals and/or metal alloys. In some embodiments the metal-based particle comprises, comprises a majority of, or consists essentially of one or more metals and/or metal alloys, along with one or more other components including, but not limited to, non-metals and/or metalloids.

As used herein, “metal-based powder” means a powder comprising or consisting of the metal-based particles as defined herein and the expression “AM powder” refers to the metal-based powder when used as a feedstock for an additive manufacturing process. In some embodiments, the metal-based powder consists solely of metal-based particles. In some embodiments, the metal-based powder comprises, or comprises a majority of, the metal-based particles along with one or more other components including but not limited to ceramics, lubricants, binders and/or other additives.

It is noted that consisting of should be understood as referring to the powder comprising, in majority, the metal-based particles, the balance being at least one of a moisture content, an oxygen content, and impurities.

As used herein, “aluminum alloy powder” means a metal-based powder primarily comprising aluminum-based particles. Aluminum-based particles means particles containing aluminum or an aluminum alloy such as, and without being limitative, AISi10Mg, AlSi7Mg, and AlCu. It can be appreciated that features described herein in relation to aluminum can be applied to other alloying metals that may be used, such as, and without being limitative, Ag, Au, Cu, Fe, Li, Mg, Mn, Ni, Pd, Sn, Ti, or Zn. It can be appreciated that other alloying rare-earth elements may be used, such as, and without being limitative, B, C, Ce, Er, Sc, Y or Zr.

As used herein in relation to powder or particles, the term “spheroidal” means that particles have a median aspect ratio greater than or equal to 0.85, 0.90, 0.95 or 0.96 (measured based on Dynamic Image Analysis according to ISO 13322-2). The terms “spherical” and “spheroidal” may be used interchangeably herein.

As used herein, the term “non-combustible” means deemed to be not readily combustible solid in ambient atmosphere (20.9% oxygen content and standard atmospheric pressure) per the standards defined by the United Nations Economic Commission for Europe Manual of Tests and Criteria.

As used herein, the term “non-explosible” means that a dispersed dust cloud is not explosible in ambient atmosphere (20.9% oxygen content and standard atmospheric pressure). To characterize the explosibility of a powder, testing can be conducted as per ASTM E1226, “Standard Test Method for Explosibility of Dust Clouds”.

In one aspect, there is provided a metal-based powder comprising metal-based particles being characterized by specific physicochemical properties (resulting from a combination of intrinsic properties and/or extrinsic properties) that confer to the powder the ability to be at least one of non-combustible or non-explosible.

In an embodiment, the metal-based powder has at least a particle size distribution (PSD) and a specific surface area tailored to avoid its explosibility. The metal-based powder is characterized by having a specific surface area of at most 0.075 m²/g, optionally at most 0.050 m²/g (measured by BET—Brunauer, Emmet, and Teller—preferably using Krypton gas, or estimated using Dynamic Image Analysis according to ISO 13322-2). The metal-based powder is further characterized by having a particle size distribution (defined by the D₅ and the D₉₅) between about 53 μm and about 150 μm, optionally between 53 μm and 106 μm, further optionally between 53 μm and 90 μm, further optionally between 71 μm and 106 μm, and yet further optionally between 71 μm and 90 μm (measured by Dynamic Image Analysis according to ISO 13322-2). Optionally, the particle size distribution is further characterized by a D₅₀ being of at least 70 μm (measured by Dynamic Image Analysis according to ISO 13322-2). Optionally, the particle size distribution is further characterized by a D₉₀ being of at least 85 μm.

As readily understood by one skilled in the art, it is noted that D₅ refers to the size class where 5% of the particles (by weight) are smaller than the lower end of the provided range (i.e., 95% of the particles by weight are larger than the lower end of the provided range) and D₉₅ refers to the size class where 95% of the particles by weight are smaller than the upper end of the provided range (i.e., 5% of the particles by weight are larger than the upper end of the provided range).

In another embodiment, the metal-based powder has a cumulative size distribution (CSD) by count that is tailored to avoid combustibility and explosibility (i.e., to be non-combustible according to the UN-ECE standard and non-explosible according to an ASTM standard). The metal-based powder is characterized by having a CSD by count including less than 20% of the metal-based particles (by count, i.e., number of particles per g of powder) that are smaller than 53 μm (measured by Dynamic Image Analysis according to ISO 13322-2). For example, the metal-based powder can be characterized by having a CSD by count including less than 20% of the metal-based particles (by count, i.e., number of particles per g of powder) that are smaller than 71 μm (measured by Dynamic Image Analysis according to ISO 13322-2). In other words, fines can be defined as particles smaller than a target size, e.g., 71 μm, and the fines content of the metal-based powder represents less than 20% of the metal-based particles by count, i.e., with respect to the total number of metal-based particles per g of powder.

In yet another embodiment, the metal-based powder has a fines content that is tailored to avoid combustibility/explosibility, the metal-based powder can have a fines content being defined by a particle count of at most 500,000 particles per gram, optionally at most 200,000 particles per gram, having a diameter smaller than or equal to 15 μm (measured based on Dynamic Image Analysis according to ISO 13322-2).

It should be noted that the enhanced properties with respect to reduction or suppression of combustibility/explosibility are achieved whilst providing other desirable properties including at least one of:
a median aspect ratio greater than or equal to 0.85, 0.90, 0.95, or 0.96 (measured based on Dynamic Image Analysis according to ISO 13322-2),
a median sphericity of greater than or equal to 0.90, 0.91, 0.92 or 0.93 (measured by Dynamic Image Analysis according to ISO 13322-2),
a moisture content being of at most 50 ppm, at most 100 ppm, at most 150 ppm, or at most 250 ppm (measured by Karl Fischer titration or moisture loss on drying during stepped heating), and
an oxygen content being of at most 1500 ppm, optionally 900 ppm, further optionally at most 300 ppm (measured by inert gas fusion).

It should be noted that the moisture content or oxygen content of the powder or metal-based particles refer to the moisture content or oxygen content of the collection of the metal-based particles.

In some implementations, the metal-based powder has the PSD, CSD by count or fine content as defined herein, and comprises or consists of spheroidal metal-based particles having a median aspect ratio greater than or equal to 0.96 (measured based on Dynamic Image Analysis according to ISO 13322-2).

In some implementations, the metal-based powder comprises or consists of spheroidal metal-based particles having a median aspect ratio greater than or equal to 0.96 and having a moisture content being of at most 250 ppm.

In some implementations, the metal-based powder comprises or consists of spheroidal metal-based particles having a median aspect ratio greater than or equal to 0.96, and an oxygen content being of at most 900 ppm.

In some implementations, the metal-based powder comprises or consists of metal-based particles having a median sphericity of at least 0.93, a median aspect ratio of at least 0.96, and a moisture content being of at most 250 ppm.

Advantageously, the metal-based powder as defined herein allows achieving non-combustibility/non-explosibility while maintaining a low moisture content, e.g., being of at most 50 ppm. In some implementations, the metal-based powder comprises or consists of metal-based particles having a median sphericity of at least 0.93, a median aspect ratio of at least 0.96, a moisture content being of at most 50 ppm, and an oxygen content being of at most 300 ppm.

In some implementations, the metal-based powder is an aluminum alloy powder designed for additive manufacturing applications. The aluminum alloy powder consists of spheroidal particles comprising an aluminum alloy as defined herein. For example, the aluminum alloy can be AISi10Mg, AlSi7Mg, AlCu, or any combinations thereof. An example AlSi10Mg powder is characterized further below.

There is also provided a method to condition a metal-based powder to confer non-explosible and/or non-combustible properties to the powder. The method includes selecting a D₉₅ of the powder in accordance with a maximum layer thickness for a given additive manufacturing application and resolution; and adjusting a specific surface area (SSA) to a target value below an SSA threshold by using at least one of sieving or dedusting.

It should be noted that the maximum layer thickness can be given in accordance with the desired feature resolution and surface properties of a final part to be manufactured. In some implementations, the maximum layer thickness is greater than or equal to 50 μm, greater than or equal to 60 μm, greater than or equal to 120 μm, or greater than or equal to 240 μm. For example, D₉₅ can be selected between 100 μm and 110 μm for a powder with an apparent density of 0.55 and a maximum layer thickness for a desired feature resolution of 60 μm, and the target value of the SSA can be adjusted below 0.075 m²/g. The adjustment of the particle size distribution and the SSA are performed while ensuring a moisture content<150 ppm, an oxygen content<900 ppm; and a fines content fewer than 500,000 particles per gram with a diameter smaller than or equal to 15 μm. For example, the moisture content can be controlled by handling the powder under a dry inert gas atmosphere, as well as producing the powder by atomization in a high-purity gas environment.

In some implementations, the method may include monitoring/measuring the CSD of the metal-based powder to verify compliance with a criterion of having the fines content of the metal-based powder represent less than 20% of the metal-based particles by count, i.e., with respect to the total number of metal-based particles per gram of powder.

Before being conditioned to confer non-explosible and/or non-combustible properties, the metal-based powder can be referred to as a starting powder material that can include or consist of the metal-based particles as defined herein, preferably aluminum-based particles, having a spheroidal morphology, i.e., having at least one of a median aspect ratio of at least 0.85, 0.90, 0.95, or 0.96 (measured based on Dynamic Image Analysis according to ISO 13322-2), and a median sphericity of at least 0.90, 0.91, 0.92 or 0.93 (measured by Dynamic Image Analysis according to ISO 13322-2). Optionally, the metal-based particles further have a moisture content being of at most 50 ppm, at most 100 ppm, at most 150 ppm or at most 250 ppm (measured by Karl Fischer titration or moisture loss on drying during stepped heating). Optionally, the metal-based particles further have an oxygen content being of at most 1500 ppm, optionally 900 ppm (measured by inert gas fusion), further optionally at most 300 ppm.

Optionally, the starting powder material can be a fine-free powder as defined in U.S. patent application Ser. No. 17/053,826 being incorporated herein by reference, or a powder manufactured by the method as defined in U.S. patent application Ser. No. 17/612,170 incorporated herein by reference. Alternatively, the starting powder material can comprise spheroidal particles and the conditioning can include a dedusting step to remove a fine fraction from the starting powder material and produce a starting powder having a fines content fewer than 500,000 particles per gram, optionally fewer than 200,000 particles per gram, with a diameter smaller than or equal to 15 μm.

In another aspect, there is provided a method for printing a high-density artefact via additive manufacturing, the method including using the metal-based powder as defined herein at a build rate between 25 cm³/hr and 1000 cm³/hr, optionally between 100 cm³/hr and 600 cm³/hr.

The density artefact is a rectangular prism made of printed layers and including a final layer being perpendicular to a cut/polish plane, thereby allowing monitoring and measurement of melt pools. It is noted that during printing of the artefact, each printed layer can rotate by a certain amount to ensure that weld tracks aren't on top of each other.

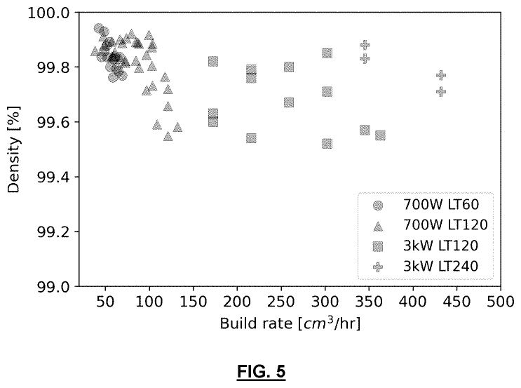

Advantageously, due to its PSD (D₅/D₅₀/D₉₅) the non-explosible powder enables high-density prints at significant laser powers. It has been shown that while at lower laser powers (e.g., 700 W), a build density of a printed artefact falls off with higher printing speeds, at higher laser powers the build density stays constant. Referring to FIG. 5, the build density versus theoretical build rate is shown for two different laser powers (700 W and 3 kW) and three different layer thicknesses (60 μm, 120 μm, 240 μm) that are used to print the density artefact via laser-based additive manufacturing, such as laser powder bed fusion additive manufacturing. It is noted that the theoretical build rate is calculated as the product of laser speed, hatch distance and layer thickness. It is noted that the build density is measured by digital optical microscopy and image analysis (or alternatively by Archimedean density, or alternatively by pycnometry) in order to identify and count the pores in a cross-sectional cut of the density artefact.

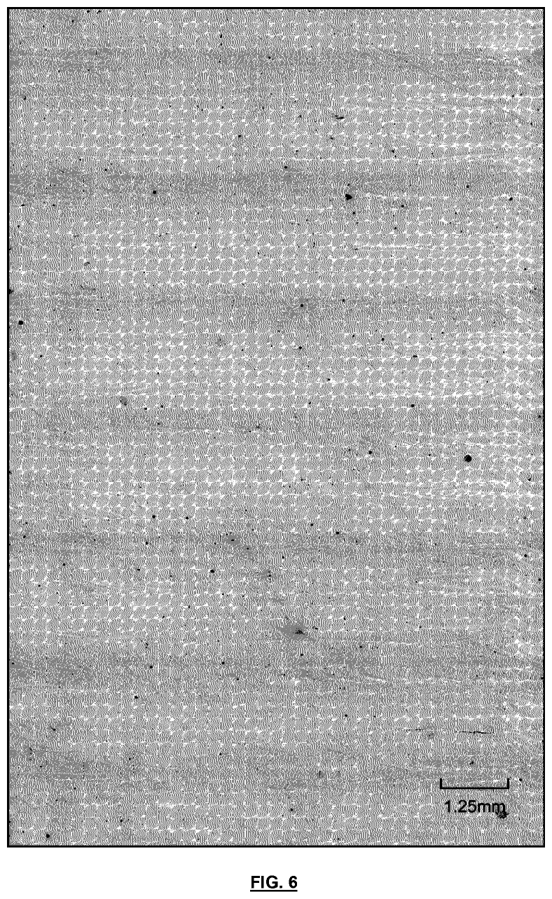

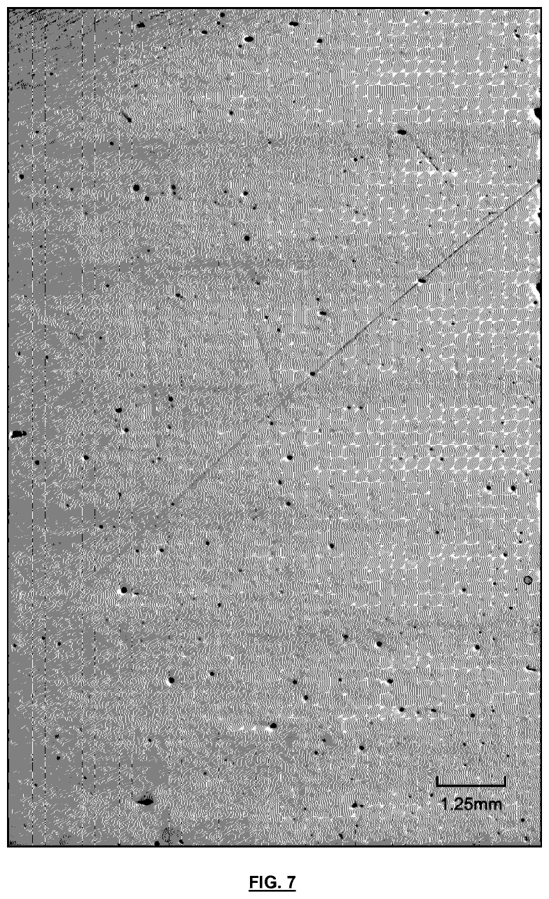

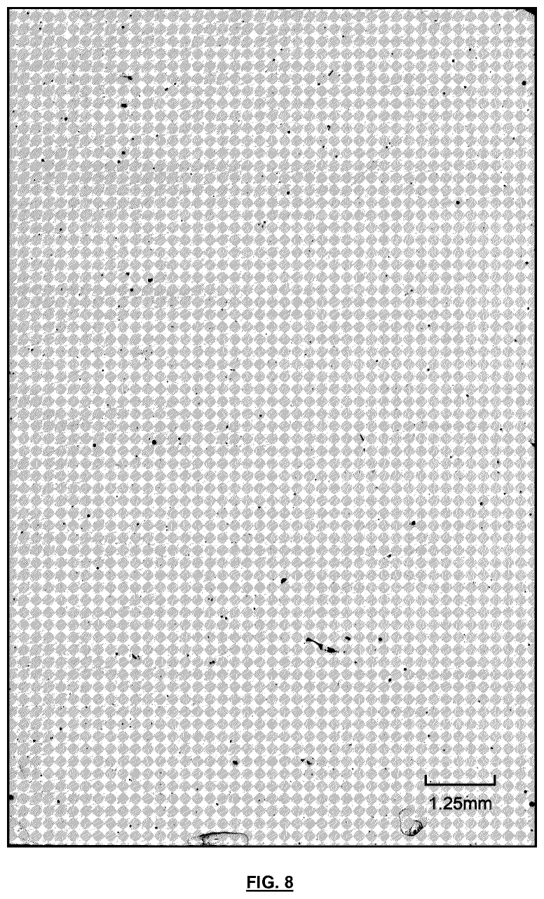

Referring to FIGS. 6 to 8, the printed density artefact was cut and polished and an image of a cross-section thereof is shown using a digital microscope. It is noted that only a very few pores are seen in the micrographs, as confirmed by the high-density values obtained in FIG. 5 by image analysis.

### Characterization of the Morphology of the Powder

Several properties are related to a morphology of a powder, including at least the specific surface area (SSA), the particle size distribution (PSD) of the powder, or the cumulative size distribution (CSD). To characterize the morphology of the powder, scanning electron microscopy can be carried out. In addition, instruments such as a Retsch CAMSIZER X2, which use dynamic image analysis (ISO 13322-2) can be used to characterize the particle sizes and shapes and counts, thereby estimating the size distribution criteria and the specific surface area. In the example below, a Zeiss EVO 25 and a CAMSIZER X2 were used to characterize the particle morphology, by measuring the size distribution criteria (PSD and/or CSD) and estimate the specific surface area.

Specific surface area can be more accurately measured by way of Brunauer-Emmett-Teller (BET) surface area measurements. In the example below, a Micromeritics TriStar II Plus with Kr adsorptive gas was used to measure the specific surface area. It is to be noted that the choice of absorptive gas has a strong influence on the measurement value, and krypton provided the desired precision.

Methods such as Karl Fischer titration or moisture loss on drying during stepped heating can be used to characterize moisture content. In the example below, an AMETEK VaporProXL using stepped heating to 275° C. was used to measure the moisture content.

Inert gas fusion can be employed to characterize oxygen content. In the example below a LECO TC600 was used to measure the oxygen content.

Example—AlSi10Mg AM powder

An AlSi10Mg powder being non-explosible was prepared by conditioning a starting powder material as per the method defined herein: define the maximum layer thickness for the desired feature resolution; choose the powder D₉₅ accordingly; adjust the specific surface area (SSA) using a combination of at least one of sieving or dedusting in order to reach a SSA<0.075 m²/g; ensure a moisture content<150 ppm and oxygen content<900 ppm; ensure a fines content fewer than 500,000 particles per gram, optionally fewer than 200,000 particles per gram, with a diameter smaller than or equal to 15 μm.

In this particular example, the non-explosible AlSi10Mg powder was designed to be used for printing at 60 μm layer thickness with a spread density of about 0.55, and a D₉₅ of 106 μm was selected accordingly. Study of the morphology of the resulting powder according to the above detailed measurement methods revealed that the resulting powder had a SSA of 0.05 m²/g, a moisture content of 50 ppm and an oxygen content of 160 ppm.

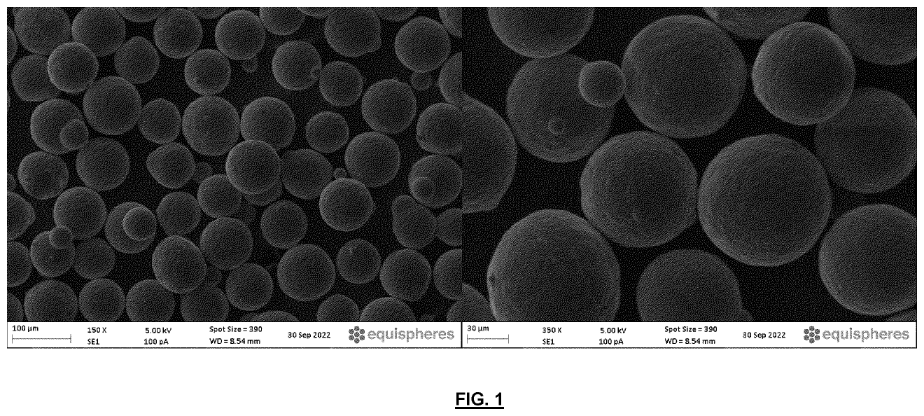

The powder morphology of this non-explosible AlSi10Mg powder imaged by SEM is shown in FIG. 1. The particles are spherical with a median aspect ratio being assessed by means of dynamic image analysis and found to be at least 0.95.

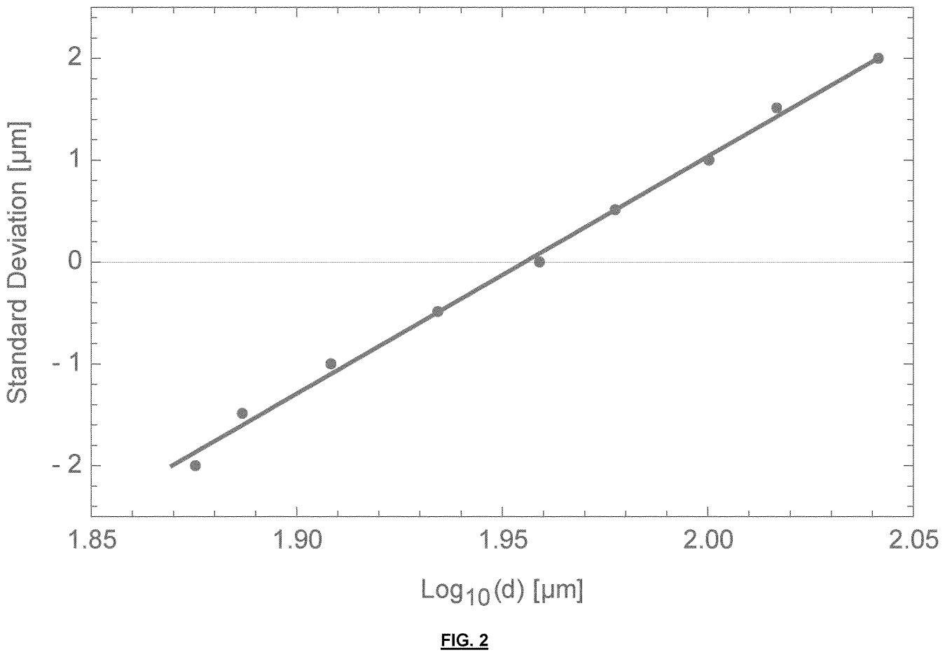

The PSD expressed in terms of the log-normal slope parameter is shown in FIG. 2. This helps to easily identify the S_{w} and the median value of the PSD. The corresponding D₁₀, D₅₀ and D₉₀ are 79 μm, 91 μm and 102 μm, respectively.

BET can be used to measure the specific surface area of the powder particles, as outlined above. The specific surface area of this example is 0.03 m²/g. The corresponding estimate of the specific surface area, as determined by CAMSIZER is <0.025 m²/g.

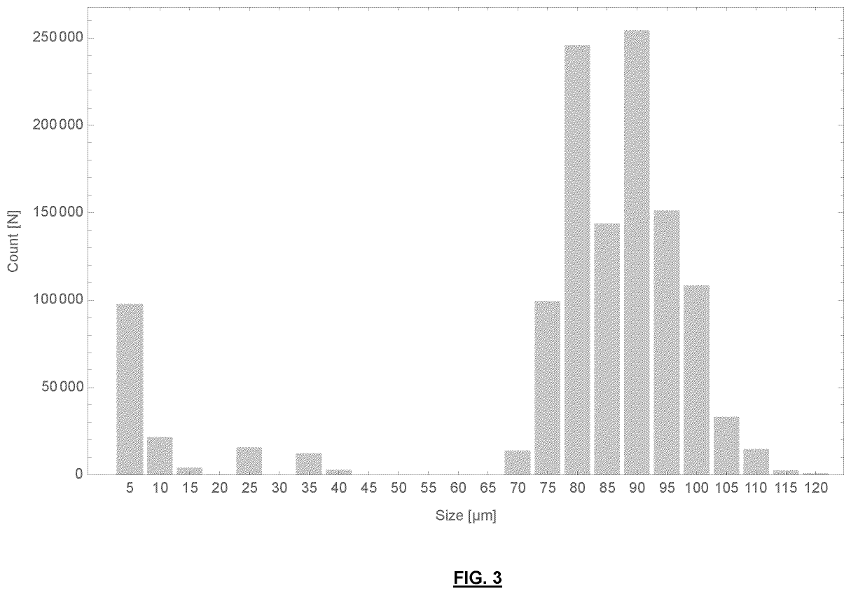

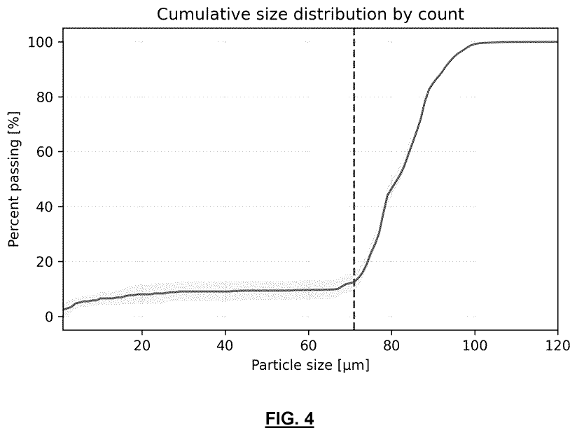

The fines content of the powder can be determined by CAMSIZER (ISO 13322-2), which can provide a particle count (number of particles per gram of powder) for a powder sample. According to one embodiment, referring to FIG. 3, the AlSi10Mg powder can be defined by the particle size distribution shown by the histogram of particle count for different particle sizes (in μm). Another way to characterize the size distribution of the powder defined herein is shown in FIG. 4. Referring to FIG. 4, a cumulative count of particles can be determined by CAMSIZER (ISO 13322-2) and further plot in accordance with the particle size so as to obtain a cumulative size distribution (CSD) by count. In the embodiment shown in FIG. 4, the AlSi10Mg powder has a cumulative count of particles that are smaller than 71 μm being less than 20% of the overall population (per gram of powder).

The explosibility of the powder can be assessed per ASTM E1226. This example AlSi10Mg powder did not ignite with 10 kJ ignition energy and dispersion concentrations of 0.5 kg/m³, 1 kg/m³, 2 kg/m³ and 3 kg/m³.

Comparative explosibility results for two metal-based powders (Table 2 being for a metal-based powder in accordance with an embodiment of the present invention) have been tested as per the following tables:

TABLE 1
Beta version of powder found to be
explosible at high concentrations

| Dust concentration [g/m³] | Explosion overpressure [barg] |
|---|---|
| 1000 | 0.06 |
| 2000 | 0.07 |
| 2500 | 0.06 |
| 3000 | 2.17 |

TABLE 2
Non-explosible AlSi10Mg

| Dust concentration [g/m³] | Explosion overpressure [barg] |
|---|---|
| 500 | 0.03 |
| 1000 | 0.02 |
| 2000 | 0.04 |
| 3000 | 0.06 |

Referring to Table 1 and the first explosibility testing, the AlSi10Mg-based powder had a D₅ of 73 μm, a D₉₅ of 105 μm, a moisture content of 47 ppm, a specific surface area of 0.0252 m²/g, and a cumulative size distribution (CSD) by count where 30% of the metal-based particles were smaller than 71 μm. That powder was found to be explosible at the highest dispersion concentration of 3000 g/m³ when tested according to ASTM E1226, “Standard Test Method for Explosibility of Dust Clouds”.

Referring to Table 2 and the second explosibility testing, the AlSi10Mg-based powder had a D₅ of 73 μm, a D₉₅ of 101 μm, a moisture content of 21 μm, a specific surface area of 0.0254 m²/g and a CSD by count where less than 20% of the metal-based particles were smaller than 71 μm. That powder was found to be non-explosible even at the highest dispersion concentration of 3000 g/m³ when tested according to ASTM E1226.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

In the above description, an embodiment is an example or implementation of the invention. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

1. A metal-based powder comprising metal-based particles, the powder having:
a specific surface area of at most 0.075 m²/g (measured based on Dynamic Image Analysis according to ISO 13322-2);
a particle size distribution between about 53 μm and about 150 μm (measured based on Dynamic Image Analysis according to ISO 13322-2); and
a fine content being defined by a particle count of at most 500,000 particles per gram having a diameter smaller than or equal to 15 μm (being measured based on Dynamic Image Analysis according to ISO 13322-2).

2. The metal-based powder of claim 1, wherein the particle size distribution is between about 53 μm and 106 μm.

3. The metal-based powder of claim 1, wherein the particle size distribution is between about 71 μm and 90 μm.

4. The metal-based powder of claim 1, wherein the particle size distribution is further characterized by a D₉₅ being of at least 90 μm.

5. The metal-based powder of claim 1, wherein the particle size distribution is further characterized by a D₅₀ being of at least 70 μm.

6. The metal-based powder of claim 1, wherein the specific surface area is of at most 0.030 m²/g.

7. The metal-based powder of claim 1, wherein the specific surface area is of at most 0.050 m²/g.

8. The metal-based powder of claim 1, wherein the metal-based particles are spheroidal and have a median aspect ratio greater than or equal to 0.85 (measured based on Dynamic Image Analysis according to ISO 13322-2).

9. The metal-based powder of claim 1, wherein the metal-based particles are spheroidal and have a median aspect ratio greater than or equal to 0.90 (measured based on Dynamic Image Analysis according to ISO 13322-2).

10. The metal-based powder of claim 1, wherein the metal-based particles are spheroidal and have a median aspect ratio greater than or equal to 0.96 (measured based on Dynamic Image Analysis according to ISO 13322-2).

11.-31. (canceled)

32. A method to condition a metal-based powder for use in an additive manufacturing process, with the metal-based powder comprising metal-based particles, the method comprising:
selecting a D₉₅ of the powder in accordance with a maximum layer thickness for a desired feature resolution of the additive manufacturing process;
performing at least one of sieving or dedusting of the powder to adjust a specific surface area (SSA) of the powder to a target value below an SSA threshold; and
recovering a coarser fraction to form a conditioned powder for use in the additive manufacturing process.

33. The method of claim 32, wherein the D₉₅ is selected to be at least 90 μm for the maximum layer thickness for the desired feature resolution being at most 50 μm.

34. The method of claim 32, wherein the SSA threshold is at most 0.075 m²/g.

35. The method of claim 32, further comprising adjusting a fine content to recover the conditioned powder having a particle count of at most 500,000 particles per gram having a diameter smaller than or equal to 15 μm (being measured based on Dynamic Image Analysis according to ISO 13322-2).

36. The method of claim 32, wherein the conditioned powder is a metal-based powder comprising metal-based particles, the powder having:
a specific surface area of at most 0.075 m²/g (measured based on Dynamic Image Analysis according to ISO 13322-2);
a particle size distribution between about 53 μm and about 150 μm (measured based on Dynamic Image Analysis according to ISO 13322-2); and
a fine content being defined by a particle count of at most 500,000 particles per gram having a diameter smaller than or equal to 15 μm (being measured based on Dynamic Image Analysis according to ISO 13322-2).

37. A method for printing a density artefact via additive manufacturing, the method including using the metal-based powder as defined in claim 1 at a build rate between 25 cm³/hr and 1000 cm³/hr.

38. The method of claim 37, wherein the build rate is between 100 cm³/hr and 600 cm³/h.

39. The method of claim 37, wherein the density artefact has a build density of at least 85% (measured by digital microscopy and image analysis).

40. The method of claim 39, wherein the build density is at least 95%.

41. The method of claim 39, wherein the build density is at least 99.8%.
